(19) United States
(12) Patent Application Publication
(10) Pub. No.: US 2020/0010648 A1
(43) Pub. Date: Jan. 9, 2020

(54) RUBBER COMPOSITION FOR CONVEYOR BELT AND CONVEYOR BELT

(71) Applicant: THE YOKOHAMA RUBBER CO., LTD., MINATO-KU, TOKYO (JP)

(72) Inventor: Deqing ZOU, HIRATSUKA CITY, KANAGAWA (JP)

(21) Appl. No.: 16/493,187

(22) PCT Filed: Dec. 27, 2017
(86) PCT No.: PCT/JP2017/046981

§ 371 Date: Sep. 11, 2019

(30) Foreign Application Priority Data
Mar. 14, 2017 (JP) 2017-048795

(51) Int. Cl. C08L 9/00; C08K 3/04; B65G 15/34

(52) U.S. Cl. CPC C08L 9/00; C08K 2201/006; B65G 15/34; C08K 3/04

(57) ABSTRACT

A rubber composition for a conveyor belt includes: a rubber component containing more than 50 mass % and 100 mass % or less of a butadiene rubber; and carbon black, in which a ratio of weight average molecular weight of the butadiene rubber to a long chain branching index of the butadiene rubber is 5.0×10⁴ to 16.6×10⁴, a content of the carbon black is from 60 to 100 parts by mass with respect to 100 parts by mass of the rubber component, a nitrogen adsorption specific surface area of the carbon black is from 85 to 160 m²/g, and a dibutyl phthalate oil absorption amount of the carbon black is from 105 to 140 mL/100 g. A conveyor belt includes: an upper surface cover rubber layer formed of the rubber composition for a conveyor belt; a reinforcing layer; and a lower surface cover rubber layer.

### TECHNICAL FIELD

The present invention relates to a rubber composition for a conveyor belt and a conveyor belt.

### BACKGROUND ART

In recent years, a conveyor belt having a long life is required from the viewpoint of considering the environment. Regarding such a problem, a rubber composition for improving a wear resistance life of a belt conveyor has been proposed in the related art. For example, Patent Document 1 discloses a rubber composition for a belt of a belt conveyor containing a polybutadiene rubber synthesized by using a neodymium-based catalyst as a rubber component.

### CITATION LIST

### Patent Literature

Patent Document 1: JP 2003-105136 A

### SUMMARY OF INVENTION

### Technical Problem

In such circumstances, the present inventors prepared a rubber composition with reference to Patent Document 1 and evaluated it, and as a result, found that such a rubber composition does not satisfy wear resistance or workability in some cases.

Therefore, an object of the present invention is to provide a rubber composition for a conveyor belt having excellent wear resistance and workability and a conveyor belt.

### Solution to Problem

As a result of diligent research to solve the problem described above, the present inventors found that in a case where a rubber component containing a butadiene rubber in a predetermined amount, and carbon black are contained, and a ratio of weight average molecular weight of the butadiene rubber to a long chain branching index of the butadiene rubber, a content, a nitrogen adsorption specific surface area, and a dibutyl phthalate oil absorption amount of the carbon black are within a predetermined range, a desired effect can be obtained, thereby completing the present invention.

The present invention is based on the findings described above and, specifically, solves the problem described above by the following features.

1. A rubber composition for a conveyor belt containing: a rubber component containing more than 50 mass % and 100 mass % or less of a butadiene rubber; and carbon black, wherein a ratio of weight average molecular weight of the butadiene rubber to a long chain branching index of the butadiene rubber (weight average molecular weight/long chain branching index) is from 5.0×10⁴ to 16.6×10⁴, a content of the carbon black is from 60 to 100 parts by mass with respect to 100 parts by mass of the rubber component, a nitrogen adsorption specific surface area of the carbon black is from 85 to 160 m²/g, and a dibutyl phthalate oil absorption amount of the carbon black is from 105 to 140 mL/100 g.

2. The rubber composition for a conveyor belt described in 1 above, in which the weight average molecular weight is from 500000 to 1000000.

3. The rubber composition for a conveyor belt according to 1 or 2 above, in which the long chain branching index is from 0.1 to 12.0.

4. A conveyor belt including: an upper surface cover rubber layer formed of the rubber composition for a conveyor belt described in any one of 1 to 3 above; a reinforcing layer; and a lower surface cover rubber layer.

### Advantageous Effects of Invention

The rubber composition for a conveyor belt of the present invention and the conveyor belt of the present invention are excellent in wear resistance and workability.

### BRIEF DESCRIPTION OF DRAWING

FIG. 1 is a cross-sectional perspective view schematically illustrating an example of a conveyor belt according to a preferred embodiment of the present invention.

### DESCRIPTION OF EMBODIMENTS

The present invention is described in detail below.

Note that in the present specification, numerical ranges indicated using “(from) . . . to . . . ” include the former number as the lower limit value and the latter number as the upper limit value.

In the present specification, unless otherwise noted, a single corresponding substance may be used for each component, or a combination of two or more types of corresponding substances may be used for each component. When a component contains two or more types of substances, the content of the component means the total content of the two or more types of substances.

In the present specification, a case where at least any one of wear resistance and workability is more excellent may be referred to as “effects of the present invention are excellent”.

### Rubber Composition for Conveyor Belt

A rubber composition for a conveyor belt of the present invention (a composition of the present invention) contains a rubber component containing more than 50 mass % and 100 mass % or less of a butadiene rubber, and carbon black, in which a ratio of weight average molecular weight of the butadiene rubber to a long chain branching index of the butadiene rubber (weight average molecular weight/long chain branching index) is from 5.0×10⁴ to 16.6×10⁴, a content of the carbon black is from 60 to 100 parts by mass with respect to 100 parts by mass of the rubber component, a nitrogen adsorption specific surface area of the carbon black is from 85 to 160 m²/g, and a dibutyl phthalate oil absorption amount of the carbon black is from 105 to 140 mL/100 g.

The composition according to an embodiment of the present invention is thought to achieve desired effects as a result of having such a configuration.

The present inventors found that in a case where (weight average molecular weight/long chain branching index) of a butadiene rubber is large, the wear resistance of a rubber obtained by the rubber composition containing the butadiene rubber is large.

However, the present inventors found that the rubber composition containing the butadiene rubber as described above has low workability.

Regarding deterioration of workability as described above, the present inventors found that the deterioration of the workability can be improved by using carbon black having a small particle size (that is, carbon black having a predetermined range of a nitrogen adsorption specific surface area), which is generally considered that it deteriorates workability.

In addition, the present inventors found that the carbon black is used in a larger amount than in the related art with respect to the rubber component containing the butadiene rubber in half of an amount or more, such that both the wear resistance and workability with a high level can be achieved.

Each of the components included in the composition according to an embodiment of the present invention will be described in detail below.

### Rubber Component

The composition of the present invention contains a rubber component and the rubber component contains butadiene rubber.

### Butadiene Rubber

Butadiene rubber (BR) is a homopolymer of butadiene.

### Weight Average Molecular Weight of Butadiene Rubber

The weight average molecular weight of the butadiene rubber is preferably from 500000 to 1000000 and more preferably from 500000 to 800000 from the viewpoint of more excellent effects (wear resistance and workability) of the invention.

In the present invention, the weight average molecular weight of the butadiene rubber is expressed in terms of a standard polystyrene based on a value measured by gel permeation chromatography (GPC) using cyclohexane as a solvent.

### Long Chain Branching Index of Butadiene Rubber

The long chain branching index (LCB index) of the butadiene rubber is preferably from 0.1 to 12.0, more preferably from 11.0 or less, and still more preferably 10.0 or less, from the viewpoint of more excellent effects (in particular, wear resistance) of the invention.

In the present invention, the long chain branching index of the butadiene rubber was measured by using a large amplitude oscillatory shear (LAOS) measurement method at 100° C. with RPA 2000 type analyzer (available from Alpha Technology Co., Ltd.).

The closer the long chain branching index is to zero, the lower the degree of branching of the butadiene rubber is.

For details of the long chain branching index (LCB index), for example, “FT-Rheology, a Tool to Quantify Long Chain Branching (LCB) in Natural Rubber and its Effect on Mastication, Mixing Behaviour and Final Properties.” (Henri G. Burhin, Alpha Technologies, UK 15 Rue du Culot B-1435 Hevillers, Belgium) can be referred to.

### Weight Average Molecular Weight/Long Chain Branching Index

In the present invention, a ratio (weight average molecular weight/long chain branching index) of weight average molecular weight of the butadiene rubber to the long chain branching index of the butadiene rubber is from 5.0×10⁴ to 16.6×10⁴.

The weight average molecular weight/long chain branching index is preferably from 5.3×10⁴ to 14.2×10⁴ and more preferably from 5.3×10⁴ to 10.0×10⁴ from the viewpoint of more excellent effects (wear resistance and workability) of the invention.

### Microstructure of Butadiene Rubber

The content of a 1,4-cis structure of the butadiene rubber is preferably 97% or more and more preferably 98% or more from the viewpoint of more excellent effects (in particular, wear resistance) of the present invention.

The content of a 1,4-trans structure of the butadiene rubber is preferably 1.5% or less and more preferably 1.0% or less from the viewpoint of more excellent effects (in particular, wear resistance) of the present invention.

The content of a 1,2-vinyl structure of the butadiene rubber is preferably 1.5% or less and more preferably 1.0% or less from the viewpoint of more excellent effects (in particular, wear resistance) of the present invention.

In the present invention, the microstructure of the butadiene rubber was analyzed by infrared absorption spectrum analysis. The absorption band of the 1,4-cis structure is 740 cm⁻¹, the absorption band of the 1,4-trans structure is 967 cm⁻¹, and the absorption band of the 1,2-vinyl structure is 910 cm⁻¹, and the microstructure was calculated from each absorption intensity ratio.

### Method for Producing Butadiene Rubber

Examples of a method for producing butadiene rubber include a method in which butadiene is polymerized by using, for example, a catalyst such as a cobalt-based catalyst and/or a neodymium-based catalyst to synthesize the butadiene. The cobalt-based catalyst and the neodymium-based catalyst are not particularly limited. A compound containing cobalt can be used as a cobalt-based catalyst. A compound containing neodymium (Nd) can be used as a neodymium-based catalyst.

### Content of Butadiene Rubber

In the present invention, the content of the butadiene rubber is more than 50 mass % and 100 mass % or less with respect to the total amount of the rubber component. “More than 50 mass %” means exceeding 50 mass %.

The content of the butadiene rubber is preferably from 60 to 90 mass %, more preferably from 70 to 90 mass %, and still more preferably more than 70 mass % and less than 90 mass %, from the viewpoint of more excellent effects (wear resistance and workability) of the invention.

Rubber Other than Butadiene Rubber

In the present invention, the rubber component can further contain a rubber other than the butadiene rubber.

An example of a rubber other than the butadiene rubber includes a diene rubber (except for the butadiene rubber).

Examples of the diene rubber include a natural rubber (NR), an isoprene rubber (IR), a butadiene rubber other than above, an aromatic vinyl-conjugated diene copolymer rubber (for example, a styrene-butadiene rubber (SBR)), a nitrile-butadiene rubber (NBR), an acrylonitrile-butadiene rubber, a butyl rubber (IIR), a halogenated butyl rubber (for example, Br-IIR or Cl-IIR), and a chloroprene rubber (CR). In particular, a natural and a styrene-butadiene rubber are preferable.

A method for producing a rubber component is not particularly limited. Examples thereof include known methods.

### Carbon Black

The composition of the present invention contains carbon black having a nitrogen adsorption specific surface area (N₂SA) of from 85 to 160 m²/g and a dibutyl phthalate oil absorption amount (DBP oil absorption amount) of from 105 to 140 mL/100 g.

### Nitrogen Adsorption Specific Surface Area of Carbon Black

In the present invention, the nitrogen adsorption specific surface area (N₂SA) of the carbon black is from 85 to 160 m²/g. The nitrogen adsorption specific surface area is preferable from 100 to 150 m²/g and more preferably from 115 to 145 m²/g from the viewpoint of more excellent effects (wear resistance and workability) of the invention.

The nitrogen adsorption specific surface area of the carbon black is a value obtained by measuring a nitrogen adsorption amount on a surface of the carbon black based on JIS K 6217-2:2001 “Part 2: Determination of specific surface area-Nitrogen adsorption method-Single-point procedures”.

### Dibutyl Phthalate Oil Absorption Amount of Carbon Black

In the present invention, a dibutyl phthalate oil absorption amount (DBP oil absorption amount) of the carbon black is from 105 to 140 mL/100 g. The dibutyl phthalate oil absorption amount is preferably from 110 to 135 mL/100 g and more preferably from 110 to 130 mL/100 g from the viewpoint of more excellent effects (wear resistance and workability) of the invention.

The dibutyl phthalate oil absorption amount of the carbon black is measured based on JIS K 6217-4:2008 “Carbon black for rubber-Fundamental characteristics-Part 4: Determination method of oil absorption amount”.

Examples of the carbon black include super abrasion furnace (SAF) carbon black, intermediate super abrasion furnace (ISAF) carbon black, and high abrasion furnace-high structure (HAF-HS) carbon black.

In particular, as the carbon black described above, SAF is preferable from the viewpoint of more excellent effects (in particular, wear resistance) of the present invention.

A method for producing carbon black is not particularly limited. Examples thereof include known products.

### Content of Carbon Black

In the present invention, the content of the carbon black is from 60 to 100 parts by mass with respect to 100 parts by mass of the rubber component. The content of the carbon black is preferably from 60 to 90 parts by mass and is more preferably from 60 to 80 parts by mass with respect to 100 parts by mass of the rubber component, from the viewpoint of more excellent effects (wear resistance and workability) of the present invention.

### Additives

The composition of the present invention can further contain additives other than the respective components described above within a range which does not impair the effects and object of the present invention. Examples of additives include carbon black other than a predetermined carbon black, a white filler, an anti-aging agent such as an anti-aging agent 6C, zinc oxide, a stearic acid, a processing aid, paraffin wax, aroma oil, a liquid polymer, a terpene resin, a thermosetting resin, a vulcanizing agent such as sulfur, a vulcanizing aid, a vulcanization accelerator, and a vulcanization retarder.

The content of the additives can be appropriately selected.

### Method for Producing Composition of Present Invention

A method for producing the composition of the present invention is not particularly limited. For example, the respective components described above (except for a vulcanizing agent such as sulfur and a vulcanization accelerator) are mixed with a Banbury mixer and the like to obtain a mixture, a vulcanizing agent such as sulfur and a vulcanization accelerator are added to the obtained mixture as described above, and then the mixture is mixed with a kneading roll machine and the like, thereby producing the composition of the present invention.

In addition, conditions for vulcanization of the composition of the present invention are not particularly limited. The vulcanization can be performed, for example, by heating the composition of the present invention under the condition of a temperature of from 140 to 160° C. and pressurizing it.

The composition of the present invention can be used to form a conveyor belt.

### Conveyor Belt

The conveyor belt of the present invention includes an upper surface cover rubber layer formed of the rubber composition for a conveyor belt of the present invention, a reinforcing layer, and a lower surface cover rubber layer.

The rubber composition forming the upper surface cover rubber layer is not particularly limited as long as it is the rubber composition for a conveyor belt of the present invention.

The upper surface cover rubber layer can be a single layer or a plurality of layers. This also applies to the reinforcing layer and the lower surface cover rubber layer.

The conveyor belt of the present invention will be described below using an attached drawing. However, the present invention is not limited by the attached drawing.

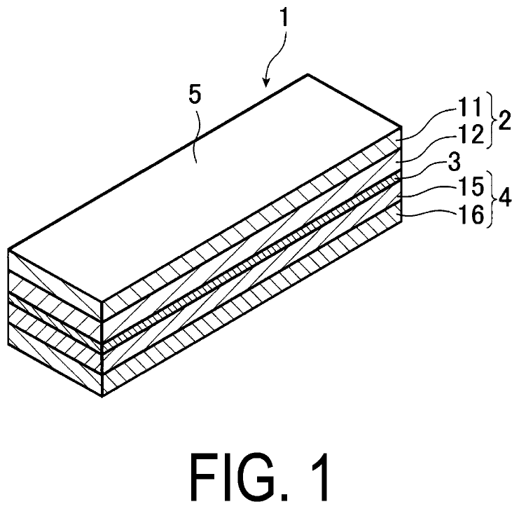

FIG. 1 is a cross-sectional perspective view schematically illustrating part of an example of a conveyor belt according to a preferred embodiment of the present invention.

In FIG. 1, a conveyor belt 1 has an upper surface cover rubber layer 2, a reinforcing layer 3, and a lower surface cover rubber layer 4, which are sequentially layered. The surface of the upper surface cover rubber layer 2 can be an object transportation conveying face 5.

In the conveyor belt of the present invention, the upper surface cover rubber layer may be formed using the composition of the present invention.

As illustrated in FIG. 1, in a case where the upper surface cover rubber layer has two or more layers, at least one of the two or more layers or all the layers can be formed using the composition of the present invention. In addition, at least the outermost layer is preferably formed using the composition of the present invention.

In FIG. 1, the upper surface cover rubber layer 2 has an outer layer 11 and an inner layer 12. The outer layer 11 and/or the inner layer 12 can be formed using the composition of the present invention and at least the outer layer 11 is preferably formed using the composition of the present invention.

In a case where the outer layer 11 is formed using the composition of the present invention, the inner layer 12 can be a layer for causing the reinforcing layer 3 and the outer layer 11 to adhere to each other.

The rubber composition used in the lower surface cover rubber layer is not particularly limited. Examples of the rubber composition include the composition of the present invention.

In FIG. 1, the lower surface cover rubber layer 4 has an outer layer 16 and an inner layer 15. The outer layer 16 and the inner layer 15 may be formed by using the same or different rubber composition(s).

The reinforcing layer is not particularly limited, and substances typically used in conveyor belts can be suitably selected and used.

The reinforcing layer can include, for example, a core body and an adhesive rubber.

Examples of a material of the core body include fibers such as a polyester fiber, a polyamide fiber, and an aramid fiber; and a metal such as steel. The fiber can be used as a canvas. The canvas refers to plain woven fabric.

The adhesive rubber is not particularly limited. Examples thereof include known products.

The shape of the reinforcing layer is not particularly limited, and may be, for example, a sheet shape as illustrated in FIG. 1. In addition, reinforcing wires (for example, steel cords) may be embedded in parallel in the reinforcing layer.

Examples of the reinforcing layer having a sheet shape include a single layer canvas and a layered body having a plurality of canvas layers.

The thickness of the upper surface cover rubber layer is preferably from 3 to 25 mm.

The thickness of the lower surface cover rubber layer is preferably from 3 to 20 mm and more preferably from 5 to 15 mm.

Note that in a case where the upper surface cover rubber layer has two or more layers, the thickness of the upper surface cover rubber layer can be a total thickness of the two or more layers. This also applies to the thickness of the lower surface cover rubber layer.

A method for producing the conveyor belt of the present invention is not particularly limited. Examples thereof include known methods.

### EXAMPLES

The present invention is described below in detail using examples.

However, the present invention is not limited to such examples.

### Production of Composition

The components shown in Table 1 below were used in compositions (part by mass) shown in the same table and mixed by an agitator to produce a composition. Specifically, first, components except for the sulfur and the vulcanization accelerator among the components listed in Table 1 were mixed with a Banbury mixer at 140° C., the sulfur and the vulcanization accelerator were added to the obtained mixture, and then the mixture was mixed with a kneading roll machine at 30° C., thereby producing a composition.

### Evaluation

The following evaluations were performed using the composition produced as described below. The results are shown in Table 1.

### Wear Resistance: DIN Wear

Preparation of Vulcanized Rubber Sheet for Evaluation

The composition produced as described above was formed in a sheet shape, and the sheet-shaped composition was heated and vulcanized at 148° C. for 30 minutes to prepare a vulcanized rubber sheet.

DIN Wear Test

A DIN wear test (B method) was performed by using the vulcanized rubber sheet described above with a DIN wear testing machine based on JIS K 6264-2:2005 6.4.1 at 25° C. and a wear volume (DIN wear) of the vulcanized rubber sheet was measured.

Evaluation Criteria

The wear volume measured as described above was represented as an index in which the result of Comparative Example 1 is set as 100.

In a case where the index is less than 100, the wear resistance is excellent.

### Workability

Roll Working

In “Production of composition”, workability (roll workability) was evaluated by visually observing a state where the rubber sheet is wound around the roll during mixing with the kneading roll machine.

Evaluation Criteria

The workability was evaluated based on the evaluation criteria below.

Good: the rubber sheet of the composition is wound around the roll without floating, and good kneading can be performed.

Marginal: the rubber sheet of the composition is wound around the roll with a little floated state, but kneading can be performed without problems.

Poor: the rubber sheet of the composition is not wound around the roll due to floating, and kneading cannot be performed.

In the present invention, when the evaluation result of the roll working is “good” or “marginal”, the workability is excellent. “Good” is more excellent than “marginal” in terms of the workability.

TABLE 1

| | Comparative Example | | | | | | Example | | | | | | | |
|---|---|---|---|---|---|---|---|---|---|---|---|---|---|---|
| | 1 | 2 | 3 | 4 | 5 | 6 | 1 | 2 | 3 | 4 | 5 | 6 | 7 | 8 |
| NR | 50 | 40 | 40 | 20 | 20 | 20 | 40 | 20 | 20 | 20 | 20 | 30 | 40 | 10 |
| BR1 | 50 | 60 | 60 | | | | 60 | | | | | | | |
| BR2 | | | | 80 | 80 | | | 80 | | 80 | 80 | 70 | 60 | 90 |
| BR3 | | | | | | | | | 80 | | | | | |
| BR4 (comparative) | | | | | | 80 | | | | | | | | |
| CB1 | 60 | 40 | | 110 | 50 | 80 | 60 | 60 | 60 | 70 | 80 | 80 | 80 | 80 |
| CB2 (comparative) | | | 40 | | | | | | | | | | | |
| Anti-aging agent 6C | 2.5 | 2.5 | 2.5 | 2.5 | 2.5 | 2.5 | 2.5 | 2.5 | 2.5 | 2.5 | 2.5 | 2.5 | 2.5 | 2.5 |
| Zinc oxide | 3 | 3 | 3 | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 | 2 | 2 | 2 |
| Paraffin wax | 1.5 | 1.5 | 1.5 | 1.5 | 1.5 | 1.5 | 1.5 | 1.5 | 1.5 | 1.5 | 1.5 | 1.5 | 1.5 | 1.5 |
| Aroma oil | 5 | 5 | 5 | 5 | 5 | 5 | 5 | 5 | 5 | 5 | 5 | 5 | 5 | 5 |
| Vulcanization accelerator | 1.4 | 1.4 | 1.4 | 1.4 | 1.4 | 1.4 | 1.4 | 1.4 | 1.4 | 1.4 | 1.4 | 1.4 | 1.4 | 1.4 |
| NS | | | | | | | | | | | | | | |
| Sulfur | 1.2 | 1.2 | 1.2 | 1.2 | 1.2 | 1.2 | 1.2 | 1.2 | 1.2 | 1.2 | 1.2 | 1.2 | 1.2 | 1.2 |
| Wear resistance | 100 | 71 | 120 | 131 | 48 | 105 | 80 | 58 | 62 | 62 | 82 | 90 | 99 | 73 |
| Workability | Good | Poor | Poor | Good | Poor | Good | Good | Marginal | Good | Good | Good | Good | Good | Marginal |

Details of the components described in Table 1 are as follows.
NR: Natural rubber; (RSS #3)
BR1: butadiene rubber, weight average molecular weight (Mw) of 770000, long chain branching index (LCB) of 8.5, Mw/LCB=9.1×10⁴ (Buna CB21, available from LANXESS, butadiene rubber obtained by copolymerizing butadiene in the presence of neodymium-based catalyst. Microstructure: 1,4-cis structure of 97.9%, 1,4-trans structure of 1.9%, and 1,2-vinyl structure of 0.2%)
BR2: butadiene rubber, weight average molecular weight (Mw) of 560000, long chain branching index (LCB) of 7.3, Mw/LCB=7.7×10⁴ (Ubepol BR-360L, available from UBE INDUSTRIES, LTD., butadiene rubber obtained by copolymerizing butadiene in the presence of cobalt-based catalyst. Microstructure: 1,4-cis structure of 97.8%, 1,4-trans structure of 0.9%, and 1,2-vinyl structure of 1.3%)
BR3: butadiene rubber, weight average molecular weight (Mw) of 500000, long chain branching index (LCB) of 9.5, Mw/LCB=5.3×10⁴ (trade name: Nipol BR1220, available from Zeon Corporation, butadiene rubber obtained by copolymerizing butadiene in the presence of cobalt-based catalyst. Microstructure: 1,4-cis structure of 98%, 1,4-trans structure of 1.0%, and 1,2-vinyl structure of 1.0%)
BR4 (comparative): butadiene rubber, weight average molecular weight (Mw) of 380000, long chain branching index (LCB) of 12.3, Mw/LCB=3.1×10⁴ (trade name: UBEPOL BR-130B, available from UBE INDUSTRIES, LTD., butadiene rubber obtained by copolymerizing butadiene in the presence of cobalt-based catalyst. Microstructure: 1,4-cis structure of 96.0%, 1,4-trans structure of 1.3%, and 1,2-vinyl structure of 2.7%)
CB1: carbon black, nitrogen adsorption specific surface area of 144 m²/g, dibutyl phthalate oil absorption amount of 115 mL/100 g (Showblack N110, SAF grade, available from Cabot Japan K.K.)
CB2 (comparative): carbon black, nitrogen adsorption specific surface area of 81 m²/g, and dibutyl phthalate oil absorption amount of 75 mL/100 g (Showblack N326, HAF-LS grade, available from Cabot Japan K.K.), CB2 is out of a predetermined range of the nitrogen adsorption specific surface area and the dibutyl phthalate oil absorption amount.
Anti-aging agent 6C: Nocrac 6C (available from Ouchi Shinko Chemical Industrial Co., Ltd.)
Zinc oxide: Zinc oxide III (available from Seido Chemical Industry Co., Ltd.)
Stearic acid: Stearic acid YR (available from NOF corporation)
Paraffin wax: OZOACE-0015 (available from Nippon Seiro Co., Ltd.)
Aroma oil: A-OMIX (available from Sankyo Yuka Kogyo K.K.)
Vulcanization accelerator NS: Nocceler NS-P, (available from Ouchi Shinko Chemical Industrial Co., Ltd.)
Sulfur: “Golden Flower” oil-treated sulfur powder (available from Tsurumi Chemical Industry Co., Ltd.)

As is clear from the results shown in Table 1, the wear resistance was poor in Comparative Example 1 in which the content of the butadiene rubber is lower than the predetermined range.

Comparative Example 2 in which the content of the carbon black is lower than the predetermined range was poorer than Comparative Example 1 in terms of the workability.

In addition, Comparative Example 3, in which the nitrogen adsorption specific surface area and the dibutyl phthalate oil absorption amount of the carbon black are outside the predetermined range and the content of the carbon black is lower than the predetermined range, was poorer than Comparative Example 1 in terms of the wear resistance and workability.

Comparative Example 4 in which the content of the carbon black is larger than the predetermined range was poorer than Comparative Example 1 in terms of the wear resistance.

Comparative Example 5 in which the content of the carbon black is lower than the predetermined range was poorer than Comparative Example 1 in terms of the workability.

Comparative Example 6 in which the weight average molecular weight/long chain branching index of the carbon black is outside the predetermined range was poorer than Comparative Example 1 in terms of the wear resistance.

Meanwhile, the composition of the present invention was excellent in the wear resistance and the workability.

### REFERENCE SIGNS LIST

1 Conveyor belt
2 Upper surface cover rubber layer
3 Reinforcing layer
4 Lower surface cover rubber layer
5 Object transportation conveying face
11, 16 Outer layer
12, 15 Inner layer

1. A rubber composition for a conveyor belt comprising:
a rubber component containing more than 50 mass % and 100 mass % or less of a butadiene rubber; and
carbon black,
wherein a ratio of weight average molecular weight of the butadiene rubber to a long chain branching index of the butadiene rubber (weight average molecular weight/long chain branching index) is from 5.0×10⁴ to 16.6×10⁴,
a content of the carbon black is from 60 to 100 parts by mass with respect to 100 parts by mass of the rubber component,
a nitrogen adsorption specific surface area of the carbon black is from 85 to 160 m²/g, and
a dibutyl phthalate oil absorption amount of the carbon black is from 105 to 140 mL/100 g.

2. The rubber composition for a conveyor belt according to claim 1, wherein the weight average molecular weight is from 500000 to 1000000.

3. The rubber composition for a conveyor belt according to claim 1, wherein the long chain branching index is from 0.1 to 12.0.

4. A conveyor belt comprising:
an upper surface cover rubber layer formed of the rubber composition for a conveyor belt described in claim 1;
a reinforcing layer; and
a lower surface cover rubber layer.

5. The rubber composition for a conveyor belt according to claim 2, wherein the long chain branching index is from 0.1 to 12.0.

6. A conveyor belt comprising:
an upper surface cover rubber layer formed of the rubber composition for a conveyor belt described in claim 2;
a reinforcing layer; and
a lower surface cover rubber layer.

7. A conveyor belt comprising:
an upper surface cover rubber layer formed of the rubber composition for a conveyor belt described in claim 3;
a reinforcing layer; and
a lower surface cover rubber layer.

8. A conveyor belt comprising:
an upper surface cover rubber layer formed of the rubber composition for a conveyor belt described in claim 5;
a reinforcing layer; and
a lower surface cover rubber layer.
